(19) United States
(12) Patent Application Publication
(10) Pub. No.: US 2005/0013505 A1
(43) Pub. Date: Jan. 20, 2005

(54) Shading correction apparatus, shading correction method, interpolation operation apparatus and interpolation operation method for use in shading correction apparatus and an applied apparatus thereof

(75) Inventors: Hisashi Nishimura, Tokyo (JP); Akira Ueno, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 10/885,801

(22) Filed: Jul. 8, 2004

(30) Foreign Application Priority Data
Jul. 16, 2003 (JP) 2003-197723

(51) Int. Cl. G06K 9/40

(52) U.S. Cl. 382/274

(57) ABSTRACT

Disclosed herein is a shading correction apparatus having a coefficient operation section for obtaining shading correction coefficients by first and second operation units for computing correction coefficient components in crossing first and second directions of an observed pixel, each operation unit including: a look-up table in which coefficient components at a plurality of reference points having different intervals corresponding to a magnitude of changing rate of the correction coefficient components with respect to distance are stored corresponding to address; a pixel distance generator for outputting a virtual pixel location by converting the reference point intervals into equal intervals; a reference point address and distance generator for outputting reference point addresses and distance between adjacent reference points and the observed pixel with using the virtual pixel location and reference point interval; and an interpolation operation section for obtaining by means of interpolation a coefficient component based on coefficient components corresponding to two reference point addresses, distances to the adjacent reference points and the reference point interval.

This application claims benefit of Japanese Patent Application No.2003-197723 filed in Japan on Jul. 16, 2003, the contents of which are incorporated by this reference.

### BACKGROUND OF THE INVENTION

The present invention relates to shading correction apparatus and shading correction method for suitably generating shading correction coefficients corresponding to pixel locations within an image, and also relates to interpolation operation apparatus and interpolation operation method for use in the shading correction apparatus and an applied apparatus using the shading correction apparatus.

Shading correction apparatus for example one as disclosed in Japanese Patent Application Laid-Open 62-168278 have been proposed as that for outputting values stored in ROM as shading correction coefficients corresponding to the locations of each pixel within an image. The proposed apparatus has a pixel location counter for each of horizontal and vertical directions and two ROMs and determines a shading correction coefficient based on data read out from the ROMs corresponding to the count values in the respective counters.

### SUMMARY OF THE INVENTION

It is an object of the present invention to provide a shading correction apparatus and shading correction method, an interpolation operation apparatus and interpolation operation method for use in the shading correction apparatus and also to provide an applied apparatus using the shading correction apparatus in which shading correction coefficients are approximated to a broken line function corresponding to distance from an optical axis center so that memory capacity is made smaller by reducing the number of the shading correction coefficients to be stored, and in which the amount of operation processing can be reduced and a reduced circuit size and improved operation speed can be achieved by contriving an approximating method to the broken line function.

In a first aspect of the invention, there is provided a shading correction apparatus including: a first operation unit for computing a correction coefficient component in a first direction of a shading correction coefficient of an observed pixel; a second operation unit for computing a correction coefficient component in a second direction crossing the first direction of the shading correction coefficient; and a coefficient operation section for obtaining a shading correction coefficient at the observed pixel based on two operation results from the first and second operation units. At least one of the first operation unit or the second operation unit includes: a look-up table for storing correspondingly to address correction coefficient components at each of a plurality of reference points having different intervals according to a magnitude of changing rate of the correction coefficient components with respect to change in distance; a pixel distance generator for outputting a virtual pixel location by converting the location of the observed pixel as seen from an optical axis center so as to equalize reference point intervals regarded as distance between reference points that are adjacent to each other; a reference point address and distance generator for outputting reference point addresses corresponding to a plurality of reference points in the vicinity of the observed pixel and distances to the observed pixel from the vicinity reference points based on the virtual pixel location and reference point interval; and an interpolation operation section for obtaining by means of interpolation a correction coefficient component at the location of the observed pixel based on the correction coefficient components corresponding to the plurality of reference point addresses in the vicinity thereof outputted from the look-up table, distances from the observed pixel to the vicinity reference points and the reference point interval.

An embodiment according to the first aspect corresponds to that shown in FIG. 1.

In a second aspect of the invention, the pixel distance generator in the shading correction apparatus according to the first aspect includes: a pixel initial location setter for setting a virtual initial location of pixel; a pixel interval setter for setting a virtual pixel interval corresponding to the virtual pixel location; a pixel location generator for generating a virtual pixel location based on the initial location of pixel and the virtual pixel interval; and an absolute value operation section for computing an absolute value of the virtual pixel location outputted from the pixel location generator.

An embodiment of the second aspect corresponds to the construction shown in FIG. 4.

In a third aspect of the invention, the pixel initial location setter in the shading correction apparatus according to the second aspect sets an initial location of pixel to a negative value.

An embodiment of the invention according to the third aspect corresponds to the construction shown in FIG. 4.

In a fourth aspect of the invention, the pixel interval setter in the shading correction apparatus according to the second aspect includes: a pixel interval storage for storing a plurality of virtual pixel intervals corresponding to the virtual pixel locations; a deciding section for deciding a timing for switching the virtual pixel intervals; and a selector for selecting and outputting a corresponding virtual pixel location based on an output from the deciding section.

An embodiment of the fourth aspect corresponds the construction shown in FIG. 5.

In a fifth aspect of the invention, the pixel interval storage in the shading correction apparatus according to the fourth aspect has a plurality of storage for storing each virtual pixel interval.

An embodiment of the fifth aspect corresponds to the construction shown in FIG. 5.

In a sixth aspect of the invention, the pixel location generator in the shading correction apparatus according to the second aspect includes: an adder for adding together a virtual pixel interval and the virtual pixel location of a pixel preceding the observed pixel; and a selector into which a result of an addition from the adder and the virtual initial location are inputted, for selecting the virtual initial location at the time of inputting of a start signal or selecting the result of the addition in other cases to output it as a virtual pixel location of the observed pixel. The virtual pixel location outputted from the selector is inputted into the adder as a virtual pixel location of the pixel preceding an observed pixel.

An embodiment of the sixth aspect corresponds to the construction shown in FIG. 6.

In a seventh aspect of the invention, the reference point interval in the shading correction apparatus according to the first aspect is set to 2^{N} (N: a positive integer), and the reference point address and distance generator includes a divider for shifting the virtual pixel location by N bits and an adder for adding “1” to a quotient of a result of the division. It outputs the quotient of the result of the division and a result of an addition from the adder as reference point addresses corresponding to two reference points adjacent to the observed pixel and outputs a remainder of the result of the division as distance from one reference point to the observed pixel.

An embodiment of the seventh aspect corresponds to the construction shown in FIG. 7.

In an eighth aspect of the invention, the reference point interval in the shading correction apparatus according to the first aspect is set to 2^{N} (N: a positive integer), and the interpolation operation section includes: a subtractor for subtracting distance from one of the adjacent reference points to the observed pixel from the reference point interval to derive distance from the other reference point; a first multiplier for multiplying distance from the one reference point by a correction coefficient component corresponding to the same reference point; a second multiplier for multiplying distance from the other reference point by a correction coefficient component corresponding to the same reference point; an adder for adding together a result at the first multiplier and a result at the second multiplier; and a divider for shifting a result at the adder by N bits to execute a division. It outputs a result of the division as a correction coefficient component at the location of the observed pixel.

An embodiment of the eighth aspect corresponds to the construction shown in FIG. 8.

In a ninth aspect of the invention, the pixel initial location setter in the shading correction apparatus according to the second aspect has a virtual initial location having an absolute value not exceeding the multiplication of (total number of reference points−1) by the reference point interval as its virtual initial location.

An embodiment of the ninth aspect corresponds to the embodiment shown in FIG. 1.

In a tenth aspect of the invention, the look-up table in the shading correction apparatus according to the first aspect has two memories, and each memory stores one of the correction coefficient components at the adjacent reference points.

An embodiment of the tenth aspect corresponds to the construction shown in FIG. 9.

In an eleventh aspect of the invention, there is provided a shading correction apparatus including: a look-up table for storing correspondingly to address shading correction coefficients at each of a plurality of reference points having different intervals according to a magnitude of changing rate of the shading correction coefficients with respect to change in distance; a pixel distance generator for outputting a virtual pixel location by converting the location of an observed pixel as seen from an optical axis center so as to equalize reference point intervals regarded as distance between reference points that are adjacent to each other; a reference point address and distance generator for outputting reference point addresses corresponding to a plurality of reference points in the vicinity of the observed pixel and distances to the observed pixel from the vicinity reference points based on the virtual pixel location and reference point interval; and an interpolation operation section for obtaining by means of interpolation a shading correction coefficient at the location of the observed pixel based on the shading correction coefficients corresponding to the plurality of reference point addresses in the vicinity thereof outputted from the look-up table, distances from the observed pixel to the vicinity reference points and the reference point interval.

An embodiment of the eleventh aspect corresponds to the embodiment shown in FIG. 1.

In a twelfth aspect of the invention, there is provided an interpolation operation apparatus including: a look-up table for storing correspondingly to address function values at each of a plurality of reference points regarded as sampling points having different sampling intervals of parameter according to a magnitude of changing rate of the function values with respect to change of parameter; a virtual parameter value generator for outputting a virtual parameter value by converting distance to an observed parameter point from an optical axis center so as to equalize reference point intervals regarded as distance between reference points that are adjacent to each other; a reference point address and distance generator for outputting reference point addresses corresponding to a plurality of reference points in the vicinity of the observed parameter point and distances to the observed parameter point from the vicinity reference points based on the virtual parameter value and reference point interval; and an interpolation operation section for obtaining by means of interpolation a function value at the observed parameter point based on the parameter values corresponding to the vicinity reference point addresses outputted from the look-up table, distances from the observed parameter point to the adjacent reference points and the reference point interval.

An embodiment of the twelfth aspect corresponds to the embodiment shown in FIG. 1.

In a thirteenth aspect of the invention, there is provided a shading correction method for computing correction coefficient components of shading correction coefficient of an observed pixel in a first direction and a second direction crossing the first direction to obtain a shading correction coefficient at the observed pixel based on the two computation results in the first and second directions, obtaining the computation results in at least one of the first or second direction by the steps of: storing into a look-up table correspondingly to address correction coefficient components at each of a plurality of reference points having different intervals according to a magnitude of changing rate of the correction coefficient components with respect to change in distance; outputting a virtual pixel location by converting distance to the observed pixel from an optical axis center so as to equalize reference point intervals regarded as distance between reference points that are adjacent to each other; outputting reference point addresses corresponding to a plurality of reference points in the vicinity of the observed pixel and distances to the observed pixel from the vicinity reference points based on the virtual pixel location and reference point interval; and obtaining by means of interpolation a correction coefficient component at the location of the observed pixel based on the correction coefficient components corresponding to the plurality of reference point addresses in the vicinity thereof outputted from the look-up table, distances from the observed pixel to the vicinity reference points and the reference point interval.

An embodiment of the thirteenth aspect corresponds to the embodiment shown in FIG. 1.

In a fourteenth aspect of the invention, there is provided a shading correction method including the steps of: storing into a look-up table correspondingly to address shading correction coefficients at each of a plurality of reference points having different intervals according to a magnitude of changing rate of the shading correction coefficients with respect to change in distance; outputting a virtual pixel location by converting distance to an observed pixel from an optical axis center so as to equalize reference point intervals regarded as distance between reference points that are adjacent to each other; outputting reference point addresses corresponding to a plurality of reference points in the vicinity of the observed pixel and distances to the observed pixel from the vicinity reference points based on the virtual pixel location and reference point interval; and obtaining by means of interpolation a shading correction coefficient at the location of the observed pixel based on the shading correction coefficients corresponding to the plurality of reference point addresses in the vicinity thereof outputted from the look-up table, distances from the observed pixel to the vicinity reference points and the reference point interval.

An embodiment of the fourteenth aspect corresponds to the embodiment shown in FIG. 1.

In a fifteenth aspect of the invention, there is provided an interpolation operation method including the steps of: storing into a look-up table correspondingly to address function values at each of a plurality of reference points regarded as sampling points having different sampling intervals of parameter according to a magnitude of changing rate of the function values with respect to change of parameter; outputting a virtual parameter value by converting distance to an observed parameter point from an optical axis center so as to equalize reference point intervals regarded as distance between reference points that are adjacent to each other; outputting reference point addresses corresponding to a plurality of reference points in the vicinity of the observed parameter point and distances to the observed parameter point from the vicinity reference points based on the virtual parameter value and reference point interval; and obtaining by means of interpolation a function value at the observed parameter point based on the parameter values corresponding to the plurality of reference point addresses in the vicinity thereof outputted from the look-up table, distances from the observed parameter point to the vicinity reference points and the reference point interval.

An embodiment of the fifteenth aspect corresponds to the embodiment shown in FIG. 1.

In a sixteenth aspect of the invention, there is provided an image processing apparatus including: an imaging section for taking an object image as image signals; a shading correction apparatus of the first aspect for correcting shading of the image signals; a memory driver for controlling writing to or reading from a memory of the image signals outputted from the shading correction apparatus; and a display section driver for controlling display onto a display section of the image signals outputted from the shading correction apparatus.

An embodiment of the sixteenth aspect corresponds to the construction shown in FIG. 11.

### BRIEF DESCRIPTION OF THE DRAWINGS

FIG. 1 is a block diagram showing an embodiment of the shading correction apparatus according to the invention.

FIG. 2A and FIG. 2B show the relationship between distance from an optical axis center and shading correction coefficients.

FIG. 3A and FIG. 3B show changes in the shading correction coefficients with respect to distances (equal interval) from an optical axis center and those with respect to virtual distances.

FIG. 4 is a block diagram showing an example of construction of the pixel distance generator in the embodiment shown in FIG. 1.

FIG. 5 is a block diagram showing an example of construction of the pixel interval setter in the pixel distance generator shown in FIG. 4.

FIG. 6 is a block diagram showing an example of construction of the pixel location generator in the pixel distance generator shown in FIG. 4.

FIG. 7 is a block diagram showing an example of construction of the reference address and distance from reference point generator in the embodiment shown in FIG. 1.

FIG. 8 is a block diagram showing an example of construction of the interpolation operation section in the embodiment shown in FIG. 1.

FIG. 9 is a block diagram showing an example of construction of the look-up table in the embodiment shown in FIG. 1.

FIG. 10 is a flowchart for explaining the processing procedure for obtaining a first correction coefficient to be executed by the first operation unit shown in FIG. 1.

FIG. 11 is a flowchart for explaining the processing procedure for obtaining a second correction coefficient to be executed by the second operation unit shown in FIG. 1.

FIG. 12 is a flowchart showing the processing procedure for obtaining a shading correction coefficient from the first and second correction coefficients obtained by the processing of the first and second operation units.

FIG. 13 is a block diagram showing construction of an image processing apparatus using the shading correction apparatus shown in FIG. 1.

### DESCRIPTION OF THE PREFERRED EMBODIMENTS

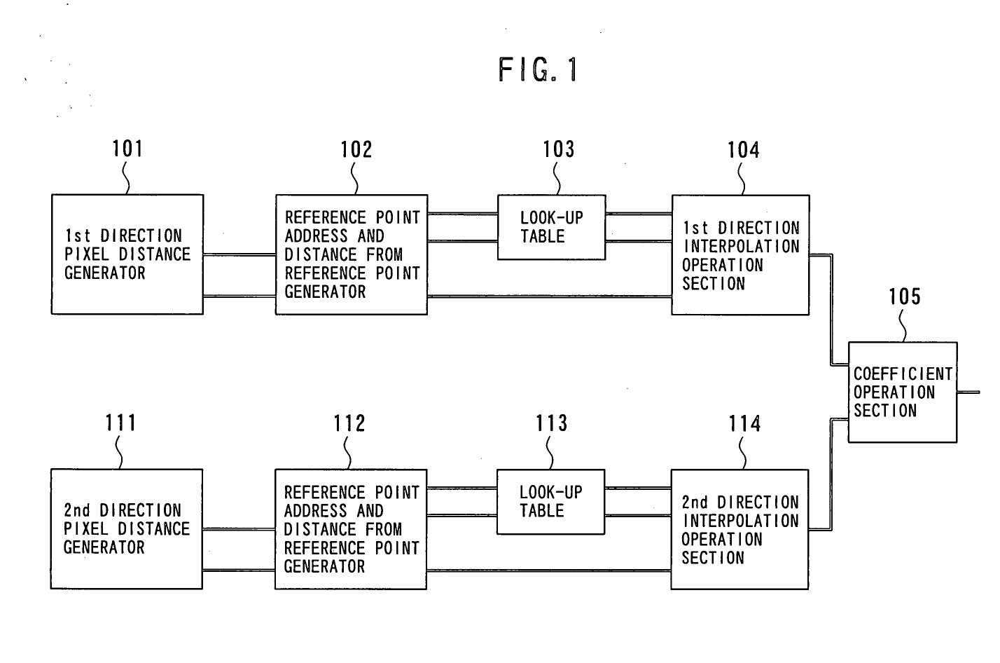

An embodiment of the invention will now be described with reference to the drawings. FIG. 1 is a block diagram showing an embodiment of the shading correction apparatus according to the invention. It should be noted that, in the following description, “distance” refers to the case of an expression simply by an absolute value, and “location” refers to the case of possessing a positive/negative sign.

FIG. 1 includes: 101, a first direction pixel distance generator; 102, a reference point address and distance from reference point generator concerning the operation processing in a first direction; 103, a look-up table concerning the operation processing in the first direction; and 104, a first direction interpolation operation section. An operation unit concerning the first direction is constituted by these components 101 to 104.

Further, it includes: 111, a second direction pixel distance generator; 112, a reference point address and distance from reference point generator concerning the operation processing in a second direction; 113, a look-up table concerning the operation processing in the second direction; and 114, a second direction interpolation operation section. An operation unit concerning the second direction is constituted by these components 111 to 114. Numeral 105 denotes a coefficient operation section for computing a shading correction coefficient based on the outputs of the respective operation units in the first and second directions.

With the shading correction apparatus according to this embodiment, a virtual distance from an optical axis center portion is given to each pixel within an image and a shading correction coefficient related to the virtual distance is computed. The present shading correction apparatus computes a correction coefficient for each of two components that are orthogonal to each other by the respective operation units to obtain a shading correction coefficient from the two correction coefficients. Since the individual processing for each component (expressed as first direction and second direction) is identical to that for the other, a description will be given below with respect to the first direction.

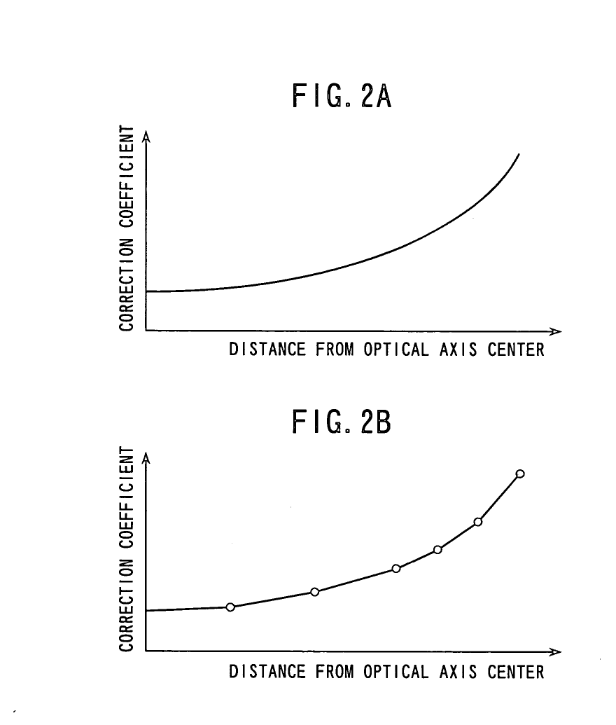

A fundamental concept here is such that ideal shading correction coefficients as shown in FIG. 2A corresponding to distances from the optical axis are approximated to a broken line as shown in FIG. 2B. The nodes of the broken line are then determined as reference points so that a shading correction coefficient at a point between each reference point can be obtained by 2-point interpolation from the values set for two reference points that are adjacent thereto.

While the broken line with a greater number of nodes make a more suitable approximation possible, the circuit size therefor will be increased due to the fact that reference points are set to the nodes and the values at the reference points are stored into a memory. For this reason, the setting of the nodes is preferably coarse where change in inclination is relatively small and is closer where more changes in inclination occur.

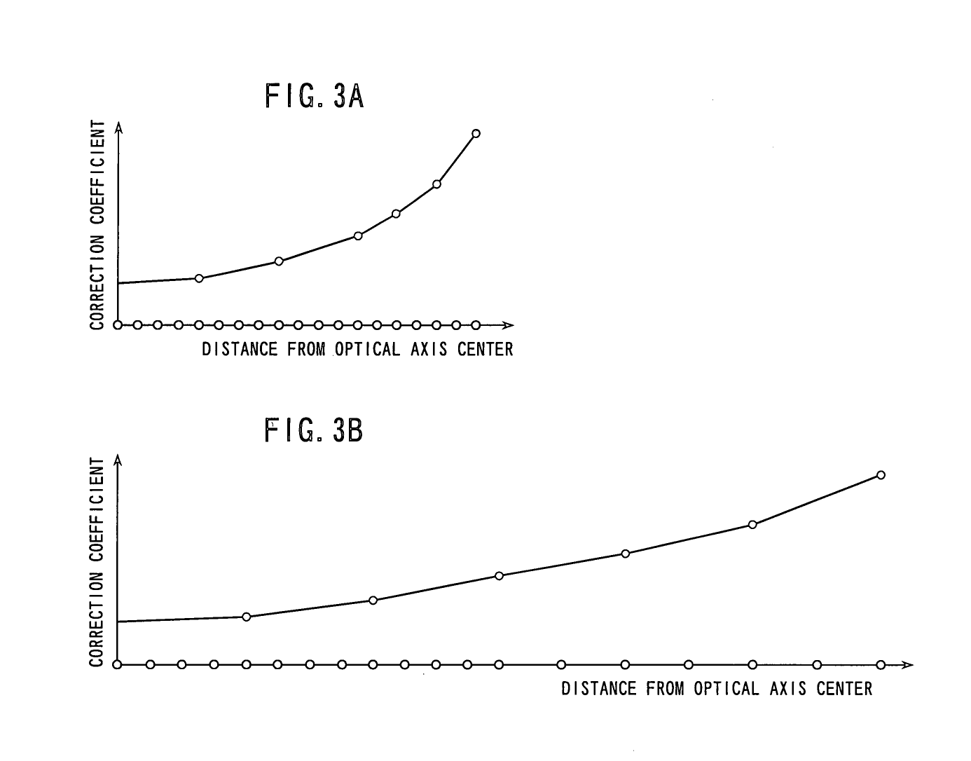

To effect the 2-point interpolation operation as the above, division processing by a reference point interval becomes necessary. While operation circuits are weak in divisions, division processing by 2^{N} (N: a positive integer) is easy. Especially when the value of the divisor is set to a constant, it suffices to simply cut specified bits. To set the reference point interval to a certain value 2^{N} (N: a positive integer), virtual intervals between pixels as shown in FIG. 3B are set for FIG. 3A. It should be noted that white dots on the horizontal axes in FIGS. 3A and 3B indicate pixel locations.

Based on the concept as described, operation of the above shading correction apparatus will now be described. For each of the components (first and second directions), the pixels are observed one by one from one end toward the other end of an image to sequentially obtain correction coefficients for the respective pixels. The first direction pixel distance generator 101 at first outputs a virtual distance and pixel interval as seen from an optical axis center. The reference point address and distance from reference point generator 102 then computes two reference point addresses and virtual distances from the reference points to the observed pixel based on a virtual distance from the optical axis center of the currently observed pixel and pixel interval thereof.

The look-up table 103 outputs the correction coefficients at the reference points from the addresses of the reference points. The first direction interpolation operation section 104 effects 2-point interpolation operation based on the correction coefficients at the two reference points and the virtual distances from the reference points to compute a correction coefficient at the observed pixel. The coefficient operation section 105 computes a shading correction coefficient at the observed pixel for example by multiplying one component by the other based on the results computed similarly for the orthogonally crossing two directions.

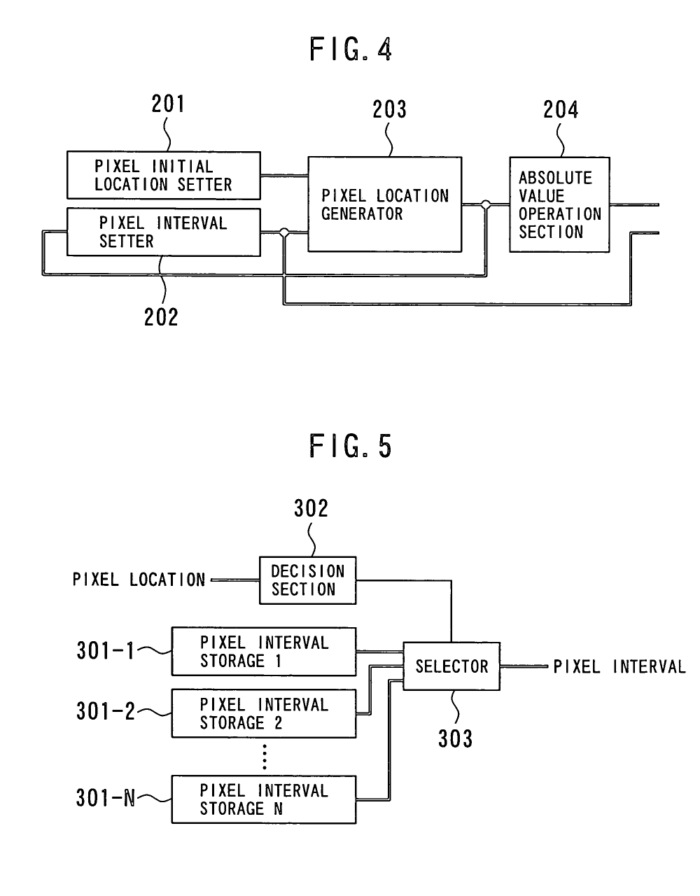

FIG. 4 is a block diagram showing an example of construction of the first direction pixel distance generator 101 in the embodiment shown in FIG. 1. FIG. 4 includes: 201, a pixel initial location setter; 202, a pixel interval setter; 203, a pixel location generator; and 204, an absolute value operation section. The pixel initial location setter 201 is a storage for setting a virtual location of the first pixel to be observed, i.e., at one end portion of the image. The pixel interval setter 202 selects and sets from among a number of candidates a virtual pixel interval between the currently observed pixel and the one observed immediately before with considering a current virtual location given from the pixel location generator 203. Based on the pixel initial location and pixel interval, the pixel location generator 203 generates a virtual location of the currently observed pixel.

The virtual distance of an image end portion from the optical axis center is set to a value not exceeding the result obtained by multiplying (number of reference points−1) by a reference point interval to be described later so that each pixel occurs necessarily on a reference point or between a reference point and another. In the present embodiment, the setting is such that one of the directions having a greater virtual distance of the image end portion from the optical axis center has a virtual distance value equal to the product of (number of reference points−1) and reference point interval so as to efficiently use the reference points and to simplify the construction of the pixel distance generator 101.

The construction of the pixel location generator 203 is to cumulatively add the virtual pixel intervals. For this reason, the value to be set to the pixel initial location setter 201 is the virtual pixel location at the end portion in the negative direction when one having a greater absolute value of virtual pixel location at end portion is set to be [(number of reference points−1)×reference point interval]. Further, the candidates for the virtual pixel interval to be set to the pixel interval setter 202 and the selecting condition thereof are set to suitable values so that one having a greater absolute value of virtual pixel location at end portion becomes [(number of reference points−1)×reference point interval]. The pixel initial location and pixel interval candidates are set to those previously prepared to meet the above described conditions.

The absolute value operator 204 computes an absolute value of the virtual location so that it be a virtual distance from the optical axis center. The reason for computing an absolute value here is that, since the shading correction coefficients are symmetrical with respect to the optical axis center, the same processing is effected for both the negative and positive sides to reduce memory capacity of the look-up table to be described later.

FIG. 5 is a block diagram showing an example of construction of the pixel interval setter 202 in the construction of the first direction pixel distance generator 101 shown in FIG. 4. FIG. 5 includes: 301-1, 301-2, . . . 301-N, a plurality of units of pixel interval storage; 302, a decision section; and 303, a selector. The pixel interval storage 301-1, 301-2, . . . 301-N, store a plurality of types of virtual pixel interval so as to give a suitable virtual location to a pixel. The decision section 302 determines a pixel interval storage to be selected by comparing the current virtual pixel location with a previously set reference value. The selector 303 selects a pixel interval based on the result at the decision section 302.

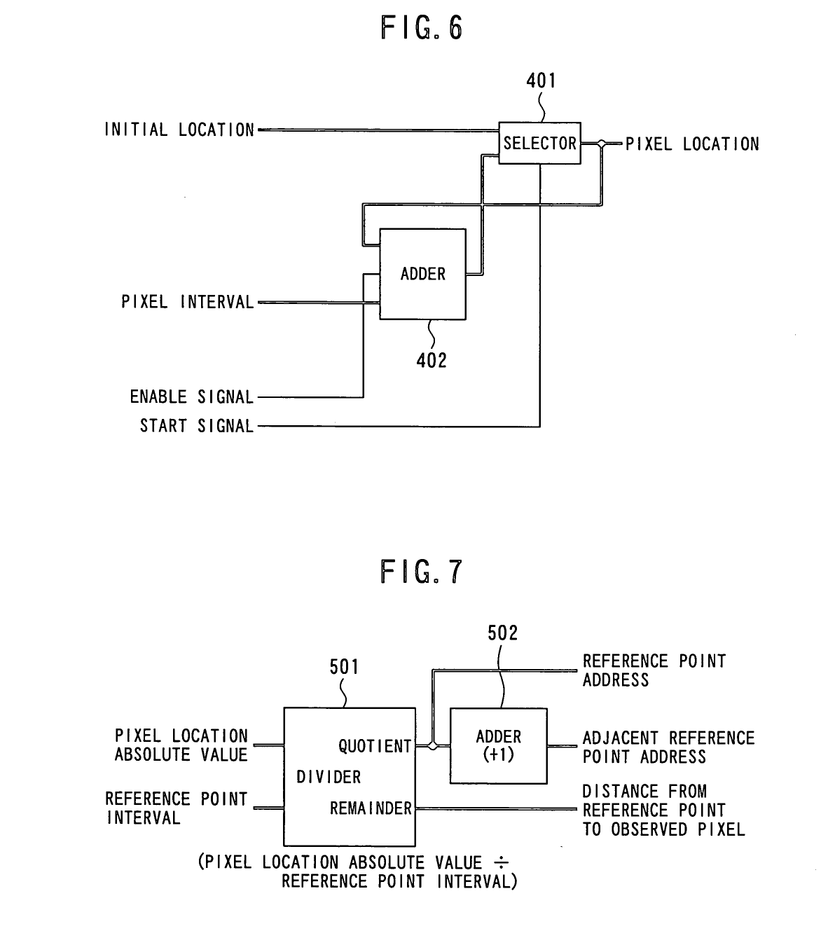

FIG. 6 is a block diagram showing an example of construction of the pixel location generator 203 in the construction of the first direction pixel distance generator 101 shown in FIG. 4. FIG. 6 includes a selector 401 and an adder 402. The selector 401 selects an initial location only when a start signal to be generated at the time of start of a scanning of the observed pixels in a certain direction is being provided and, in other cases, selects a cumulatively added value from the adder 402. The adder 402 successively adds a pixel interval to the data from selector 401 when an enabling signal to be generated a single time per one observed pixel is being provided.

FIG. 7 is a block diagram showing an example of construction of the reference point address and distance from reference point generator 102 in the embodiment shown in FIG. 1. FIG. 7 includes a divider 501 and an adder 502. The divider 501 divides a pixel location absolute value by a reference point interval. Since a reference point interval is 2^{N} (N: a positive integer), quotient of the result of the division is the N-th and high-order bits as counted from the low-order side and the remainder thereof is the low order “0” bit to (N−1)-th bit. At this time, the quotient represents a reference point address and the remainder represents a virtual distance of the observed pixel to the reference point. At the adder 502, “1” is added to the reference point address to obtain an adjacent reference point address.

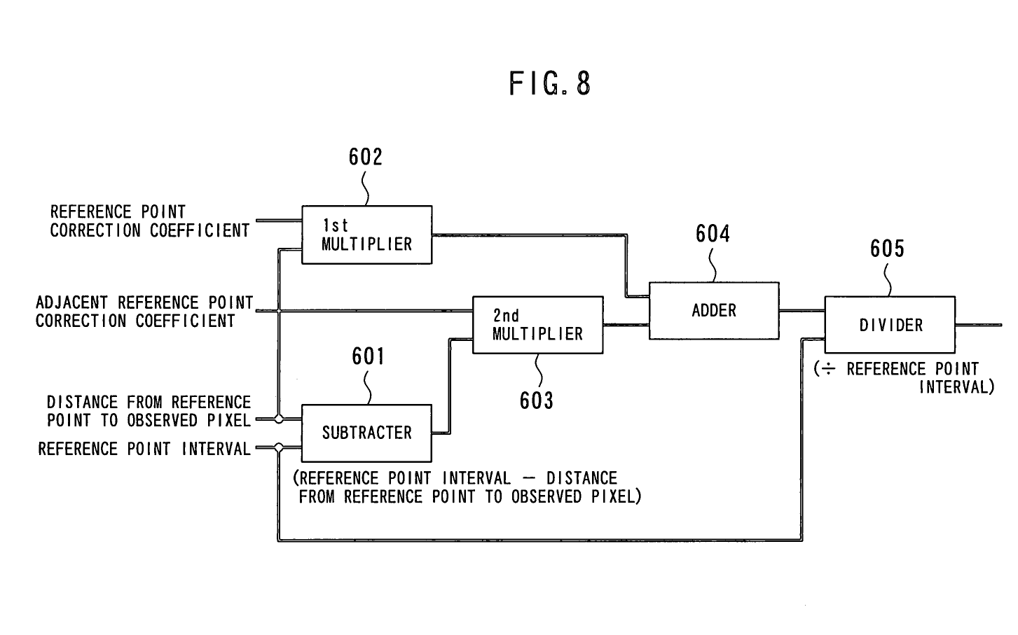

FIG. 8 is a block diagram showing an example of construction of the first direction interpolation operation section 104 in the embodiment shown in FIG. 1. FIG. 8 includes: 601, a subtracter; 602, a first multiplier; 603, a second multiplier; 604, an adder, and 605, a divider. The subtracter 601 subtracts the distance from reference point to the observed pixel from the reference point interval to obtain distance to the observed pixel from an adjacent reference point that is next to the reference point. The first multiplier 602 multiplies together a reference point correction coefficient and the distance from the reference point to the observed pixel, and the second multiplier 603 multiplies together the adjacent reference point correction coefficient and the distance from the adjacent reference point to the observed pixel. The results of multiplication at the two multipliers 602, 603 are added together at the adder 604 and is divided by the reference point interval at the divider 605. Since the reference point interval is 2^{N} (N: a positive integer), the result of the division is obtained by cutting the low-order N bits.

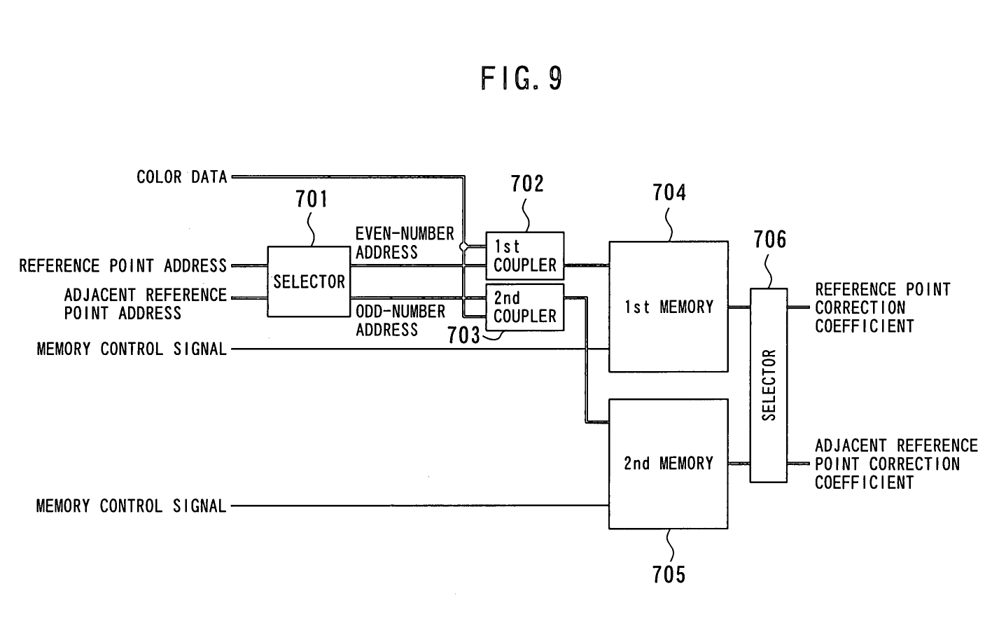

FIG. 9 is a block diagram showing an example of construction of the look-up table 103 in the embodiment shown in FIG. 1. FIG. 9 includes: 701, a selector; 702, a first coupler for bit coupling of color data to the even-number addresses; 703, a second coupler for bit coupling of color data to the odd-number addresses; 704, a first memory into which the correction coefficients of even-number addresses are stored; 705, a second memory into which the correction coefficients of the odd-number addresses are stored; and 706, a selector.

Since the reference point addresses that are adjacent to each other are necessarily of an even number and odd number, the reference point address and adjacent reference point address coming into the look-up table 103 are distributed to even-number address and odd-number address. Bit coupling of color data is effected and an address value corresponding to color is generated respectively at the first coupler 702 for the case of even-number addresses and at the second coupler 703 for the case of odd-number addresses so that the correction coefficient can be changed corresponding to color. By giving an even-number address and memory control signal to the first memory 704, the correction coefficient at an even-number reference point is obtained. By giving an odd-number address and memory control signal to the second memory 705, the correction coefficient at an odd-number reference point is obtained. The correction coefficients of the even-number and odd-number reference points are distributed to a reference point correction coefficient and adjacent reference point correction coefficient at the selector 706 and are inputted into the first direction interpolation operation section 104.

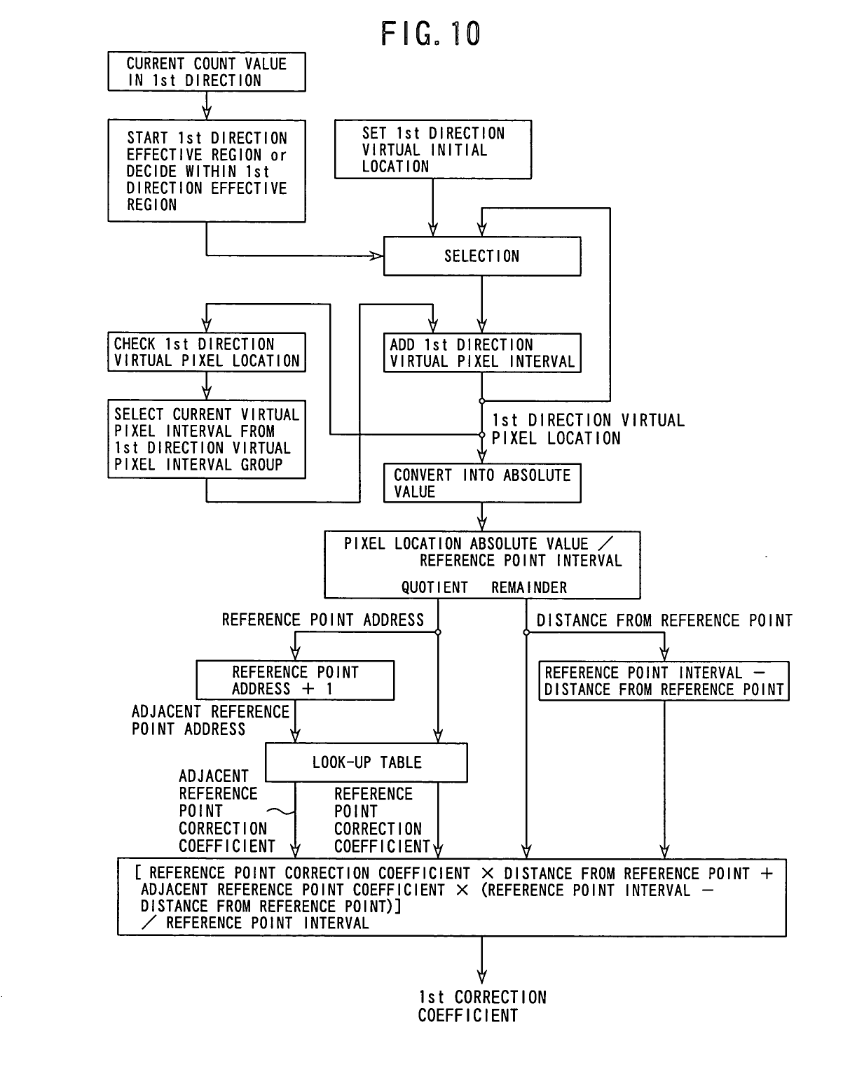

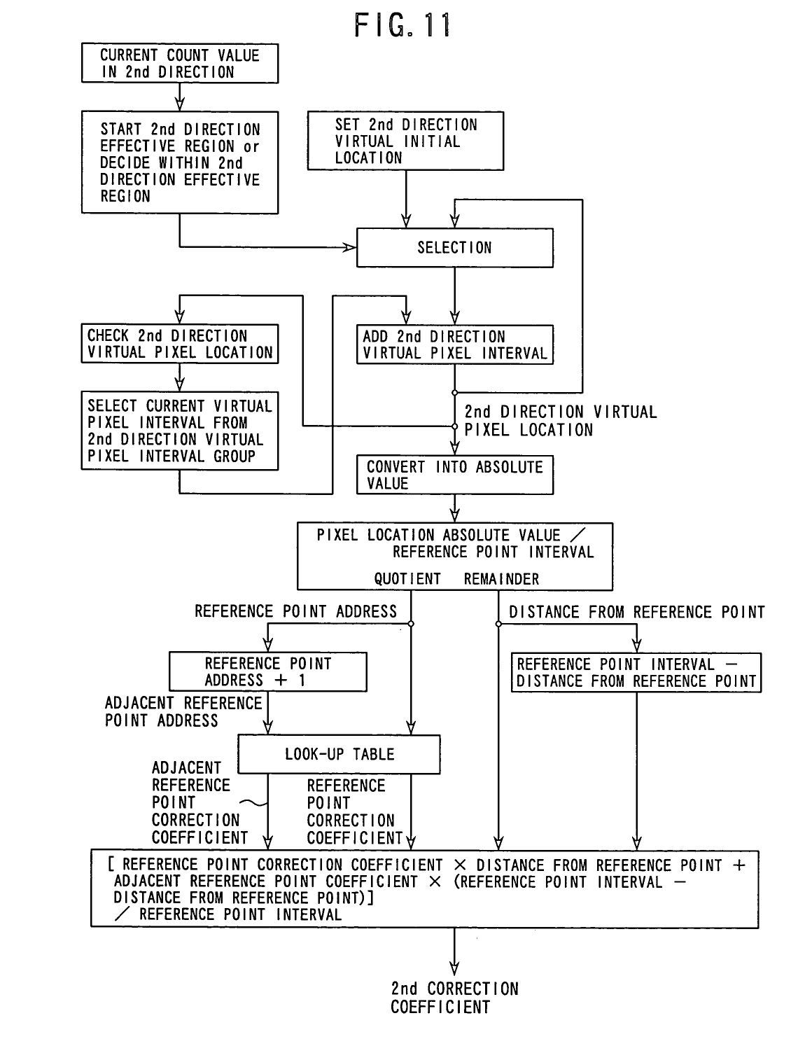

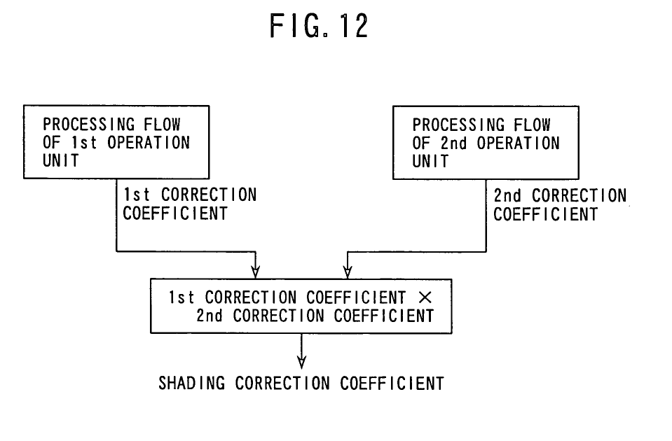

FIGS. 10 and 11 are flowcharts for showing the processing procedure for obtaining a first correction coefficient and a second correction coefficient, respectively, to be executed by the first operation unit and the second operation unit in the shading correction apparatus according to the embodiment constructed as the above. FIG. 12 is a flowchart showing the processing procedure for obtaining a shading correction coefficient from the first and second correction coefficients obtained from the processing by the first and second operation units.

The processing at the respective steps in each flowchart is obvious from the above description of operation and an explanation thereof will be omitted. Naturally the processing steps according to the above flowcharts can also be programmed and be effected as a software processing by computer.

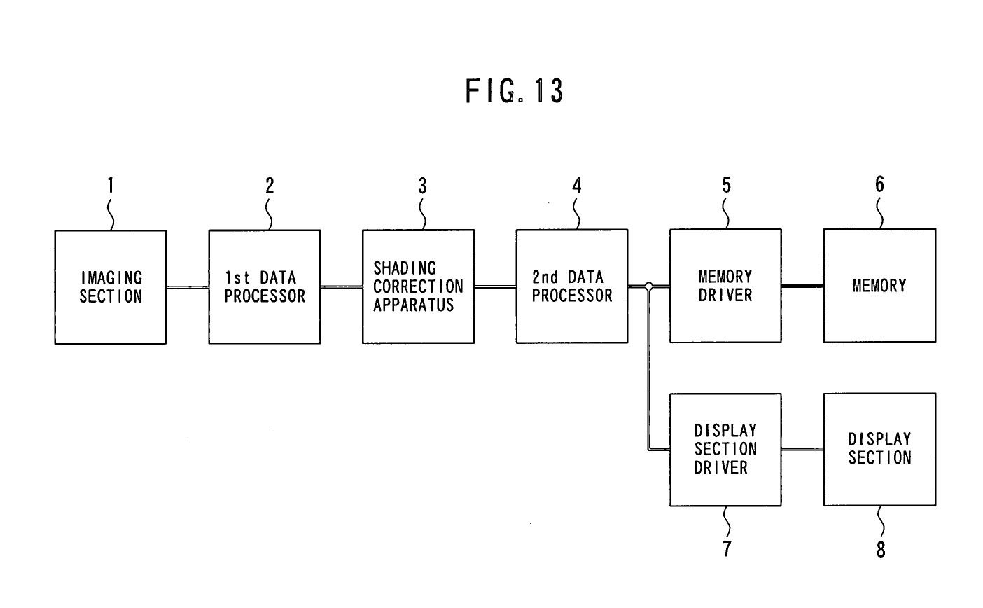

FIG. 13 is a block diagram showing the construction of an image processing apparatus to which a shading correction apparatus of the above described construction is applied. FIG. 13 includes: 1, an imaging section for taking an object image as image signals; 2, a first data processor for effecting for example white balance adjustment and gain control but shading on the image signals; 3, a shading correction apparatus of the above described construction for effecting shading correction for output image signals from the first data processor 2; 4, a second data processor for effecting for example thinning and low-pass filtering on the image signals corrected of shading; 5, a memory driver for effecting control in writing or reading the output image signals from the second data processor 4 into or from a memory 6; and 7, a display driver for effecting control in displaying the output image signals from the second data processor 4 onto a display section 8.

By applying the shading correction apparatus according to the invention to an image processing apparatus as the above, the image processing apparatus with an improved processing speed of image signals can be provided.

While, in the description of the above embodiment, correction coefficients regarding two reference points that are adjacent to an observed pixel are used to obtain a correction coefficient regarding the observed pixel, it is also possible to effect correction with using three or more reference points or to use, instead of the adjacent reference points, vicinity reference points located outwardly therefrom.

As has been described by way of the above embodiment, with the first aspect of the invention, constant intervals can be provided between the reference points by setting to each pixel a virtual distance from an optical axis center so that a shading correction apparatus can be accomplished as capable of readily detecting reference points and executing interpolation operation so as to achieve a reduced circuit size and improved operation speed.

According to the second aspect, since distance from optical axis center of each pixel can be set by cumulatively adding pixel intervals to the location of a first observed pixel, it is possible to achieve a reduced circuit size and an improved operation speed. According to the third aspect, since “0” at the optical axis center and a positive value at an end portion on the opposite side can be obtained by setting a negative value to an initial location which becomes the base for the cumulative addition, a symmetry with respect to the optical axis center can be produced to reduce memory capacity and achieve a reduced circuit size. According to the fourth and fifth aspects, since a plurality of types of virtual pixel interval can be set, there is some degree of freedom in setting the reference point intervals and it is possible to provide constant intervals between the reference points. According to the sixth aspect, since it is possible to set a virtual location of each pixel by cumulatively adding the pixel intervals, a reduced circuit size and an improved operation speed can be achieved.

According to the seventh and eighth aspects of the invention, since the divider for generating reference point addresses is only required to have a construction for bit shift when the reference point interval is set to a constant value of 2^{N} (N: a positive integer), a reduced circuit size and an improved operation speed can be achieved. It should be noted that a reference point address is obtained from the quotient at the divider and an adjacent reference point address is obtained by adding “1” thereto, and distance from the reference point to an observed pixel can be represented by the residue thereof. According to the ninth aspect, since any virtual location can be produced in a manner sandwiched between reference points, each correction coefficient can be obtained by 2-point interpolation of the reference point correction coefficients. It is theoretically possible to fully utilize the reference points by equalizing the absolute value of a virtual location at an image end portion and the product of (number of reference points−1) by the reference point interval.

According to the tenth aspect, it is possible to concurrently read the correction coefficients of a reference point and of an adjacent reference point from a look-up table so as to reduce memory access time. According to the eleventh aspect, since constant intervals can be provided between the reference points by setting to each pixel a virtual distance from an optical axis center, it is readily possible to detect reference points and execute interpolation operation so that a reduced circuit size and an improved operation speed can be achieved.

According to the twelfth aspect, constant intervals can be provided between the reference points by setting to each parameter point a virtual distance from an optical axis center so that an interpolation operation apparatus can be accomplished as capable of readily detecting reference points and executing interpolation operation so as to achieve a reduced circuit size and improved operation speed. According to the thirteenth or fourteenth aspect, since constant intervals can be provided between the reference points by setting to each pixel a virtual distance from an optical axis center, a shading correction method can be accomplished as capable of readily detecting reference points and executing interpolation operation so as to achieve a reduced circuit size and improved operation speed.

According to the fifteenth aspect, since constant intervals can be provided between the reference points by setting to each sampling point a virtual distance from an optical axis center, an interpolation operation method can be accomplished as capable of readily detecting reference points and executing interpolation operation so as to achieve a reduced circuit size and improved operation speed.

According to the sixteenth aspect, an image processing apparatus with an improved image signal processing speed can be accomplished by applying a shading correction apparatus according to the first aspect.

1. A shading correction apparatus comprising:
a first operation unit for computing a correction coefficient component in a first direction of a shading correction coefficient of an observed pixel;
a second operation unit for computing a correction coefficient component in a second direction crossing said first direction of the shading correction coefficient; and
a coefficient operation section for obtaining a shading correction coefficient at the observed pixel based on two operation results from said first and second operation units;
at least one of said first operation unit or second operation unit comprising:
a look-up table for storing correspondingly to address correction coefficient components at each of a plurality of reference points having different intervals according to a magnitude of changing rate of the correction coefficient components with respect to change in distance;
a pixel distance generator for outputting a virtual pixel location by converting the location of the observed pixel as seen from an optical axis center so as to equalize reference point intervals regarded as distance between reference points that are adjacent to each other;
a reference point address and distance generator for outputting reference point addresses corresponding to a plurality of reference points in the vicinity of the observed pixel and distances to the observed pixel from the vicinity reference points based on the virtual pixel location and reference point interval; and
an interpolation operation section for obtaining by means of interpolation a correction coefficient component at the location of the observed pixel based on the correction coefficient components corresponding to the plurality of reference point addresses in the vicinity thereof outputted from said look-up table, distances from the observed pixel to the vicinity reference points and the reference point interval.

2. The shading correction apparatus according to claim 1, wherein said pixel distance generator comprises: a pixel initial location setter for setting a virtual initial location of pixel; a pixel interval setter for setting a virtual pixel interval corresponding to the virtual pixel location; a pixel location generator for generating a virtual pixel location based on the initial location of pixel and the virtual pixel interval; and an absolute value operation section for computing an absolute value of the virtual pixel location outputted from the pixel location generator.

3. The shading correction apparatus according to claim 2, wherein said pixel initial location setter sets an initial location of pixel to a negative value.

4. The shading correction apparatus according to claim 2, wherein said pixel interval setter comprises: a pixel interval storage for storing a plurality of virtual pixel intervals corresponding to the virtual pixel locations; a deciding section for deciding a timing for switching the virtual pixel intervals; and a selector for selecting and outputting a corresponding virtual pixel location based on an output from the deciding section.

5. The shading correction apparatus according to claim 4, wherein said pixel interval storage has a plurality of storage for storing each virtual pixel interval.

6. The shading correction apparatus according to claim 2, wherein said pixel location generator comprises: an adder for adding together a virtual pixel interval and the virtual pixel location of a pixel preceding the observed pixel; and a selector into which a result of an addition from the adder and the virtual initial location are inputted, for selecting the virtual initial location at the time of inputting of a start signal or selecting the result of the addition in other cases to output it as a virtual pixel location of the observed pixel, the virtual pixel location outputted from said selector being inputted into said adder as a virtual pixel location of the pixel preceding an observed pixel.

7. The shading correction apparatus according to claim 1, wherein said reference point interval is set to 2^{N} (N: a positive integer), and wherein said reference point address and distance generator comprising a divider for shifting the virtual pixel location by N bits and an adder for adding “1” to a quotient of a result of the division, outputting the quotient of the result of the division and a result of an addition from said adder as reference point addresses corresponding to two reference points adjacent to the observed pixel and outputting a remainder of the result of the division as distance from one reference point to the observed pixel.

8. The shading correction apparatus according to claim 1, wherein said reference point interval is set to 2^{N} (N: a positive integer), and wherein said interpolation operation section comprises: a subtractor for subtracting distance from one of the adjacent reference points to the observed pixel from the reference point interval to derive distance from the other reference point; a first multiplier for multiplying distance from the one reference point by a correction coefficient component corresponding to the same reference point; a second multiplier for multiplying distance from the other reference point by a correction coefficient component corresponding to the same reference point; an adder for adding together a result at the first multiplier and a result at the second multiplier; and a divider for shifting a result at the adder by N bits to execute a division; said interpolation operation section outputting a result of the division as a correction coefficient component at the location of the observed pixel.

9. The shading correction apparatus according to claim 2, wherein said pixel initial location setter has a virtual initial location having an absolute value not exceeding the multiplication of (total number of reference points−1) by the reference point interval as its virtual initial location.

10. The shading correction apparatus according to claim 1, wherein said look-up table has two memories, and each memory stores one of the correction coefficient components at the adjacent reference points.

11. A shading correction apparatus comprising:
a look-up table for storing correspondingly to address shading correction coefficients at each of a plurality of reference points having different intervals according to a magnitude of changing rate of the shading correction coefficients with respect to change in distance;
a pixel distance generator for outputting a virtual pixel location by converting the location of an observed pixel as seen from an optical axis center so as to equalize reference point intervals regarded as distance between reference points that are adjacent to each other;
a reference point address and distance generator for outputting reference point addresses corresponding to a plurality of reference points in the vicinity of the observed pixel and distances to the observed pixel from the vicinity reference points based on the virtual pixel location and reference point interval; and
an interpolation operation section for obtaining by means of interpolation a shading correction coefficient at the location of the observed pixel based on the shading correction coefficients corresponding to the plurality of reference point addresses in the vicinity thereof outputted from said look-up table, distances from the observed pixel to the vicinity reference points and the reference point interval.

12. An interpolation operation apparatus comprising:
a look-up table for storing correspondingly to address function values at each of a plurality of reference points regarded as sampling points having different sampling intervals of parameter according to a magnitude of changing rate of the function values with respect to change of parameter;
a virtual parameter value generator for outputting a virtual parameter value by converting distance to an observed parameter point from an optical axis center so as to equalize reference point intervals regarded as distance between reference points that are adjacent to each other;
a reference point address and distance generator for outputting reference point addresses corresponding to a plurality of reference points in the vicinity of the observed parameter point and distances to the observed parameter point from the vicinity reference points based on the virtual parameter value and reference point interval; and
an interpolation operation section for obtaining by means of interpolation a function value at the observed parameter point based on the parameter values corresponding to the vicinity reference point addresses outputted from said look-up table, distances from the observed parameter point to the adjacent reference points and the reference point interval.

13. A shading correction method for computing correction coefficient components of shading correction coefficient of an observed pixel in a first direction and a second direction crossing the first direction to obtain a shading correction coefficient at the observed pixel based on the two computation results in the first and second directions, obtaining the computation results in at least one of said first or second direction by the steps of:
storing into a look-up table correspondingly to address correction coefficient components at each of a plurality of reference points having different intervals according to a magnitude of changing rate of the correction coefficient components with respect to change in distance;
outputting a virtual pixel location by converting distance to the observed pixel from an optical axis center so as to equalize reference point intervals regarded as distance between reference points that are adjacent to each other;
outputting reference point addresses corresponding to a plurality of reference points in the vicinity of the observed pixel and distances to the observed pixel from the vicinity reference points based on the virtual pixel location and reference point interval; and
obtaining by means of interpolation a correction coefficient component at the location of the observed pixel based on the correction coefficient components corresponding to the plurality of reference point addresses in the vicinity thereof outputted from the look-up table, distances from the observed pixel to the vicinity reference points and the reference point interval.

14. A shading correction method comprising the steps of:
storing into a look-up table correspondingly to address shading correction coefficients at each of a plurality of reference points having different intervals according to a magnitude of changing rate of the shading correction coefficients with respect to change in distance;
outputting a virtual pixel location by converting distance to an observed pixel from an optical axis center so as to equalize reference point intervals regarded as distance between reference points that are adjacent to each other;
outputting reference point addresses corresponding to a plurality of reference points in the vicinity of the observed pixel and distances to the observed pixel from the vicinity reference points based on the virtual pixel location and reference point interval; and
obtaining by means of interpolation a shading correction coefficient at the location of the observed pixel based on the shading correction coefficients corresponding to the plurality of reference point addresses in the vicinity thereof outputted from the look-up table, distances from the observed pixel to the vicinity reference points and the reference point interval.

15. An interpolation operation method comprising the steps of:
storing into a look-up table correspondingly to address function values at each of a plurality of reference points regarded as sampling points having different sampling intervals of parameter according to a magnitude of changing rate of the function values with respect to change of parameter;
outputting a virtual parameter value by converting distance to an observed parameter point from an optical axis center so as to equalize reference point intervals regarded as distance between reference points that are adjacent to each other;
outputting reference point addresses corresponding to a plurality of reference points in the vicinity of the observed parameter point and distances to the observed parameter point from the vicinity reference points based on the virtual parameter value and reference point interval; and
obtaining by means of interpolation a function value at the observed parameter point based on the parameter values corresponding to the plurality of reference point addresses in the vicinity thereof outputted from the look-up table, distances from the observed parameter point to the vicinity reference points and the reference point interval.

16. An image processing apparatus comprising:
an imaging section for taking an object image as image signals;
a shading correction apparatus according to claim 1 for correcting shading of said image signals;
a memory driver for controlling writing to or reading from a memory of the image signals outputted from the shading correction apparatus; and
a display section driver for controlling display onto a display section of the image signals outputted from said shading correction apparatus.
